(19) United States
(12) Patent Application Publication
(10) Pub. No.: US 2017/0079259 A1
(43) Pub. Date: Mar. 23, 2017

(54) WATER BUG TRAP

(71) Applicant: Jeffrey A. Burns, Inver Grove Heights, MN (US)

(72) Inventor: Jeffrey A. Burns, Inver Grove Heights, MN (US)

(21) Appl. No.: 14/862,000

(22) Filed: Sep. 22, 2015

(51) Int. Cl. A01M 1/04; F16B 47/00; E04H 4/16; A01M 1/10

(52) U.S. Cl. CPC A01M 1/04; A01M 1/10; F16B 47/00; E04H 4/16

(57) ABSTRACT

An outdoor swimming pool underwater aquatic-bug trap comprising a container having opaque sidewalls, a rear wall, an inward tapering front wall composed of a material that allows for the passage of light therethough, an aquatic-bug holding chamber, an aquatic-bug entry orifice located in the front wall of the container, mounting means for mounting the container underwater to a wall of an outdoor swimming pool, and an aquatic-bug attracting light source for emitting light into the container to attract aquatic-bugs through the aquatic-bug entry orifice and into the aquatic-bug holding chamber.

### FIELD OF THE INVENTION

This invention relates generally to aquatic-bug traps and more specifically an outdoor swimming pool underwater aquatic-bug trap that uses an aquatic-bug attracting light source to attract aquatic-bugs into the aquatic-bug holding chamber.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Owning an outdoor swimming pool, whether aboveground or in-ground provides a relaxing oasis for reading, meditating, sun bathing, exercise, and a great place for their owners to have parties and keep guests entertained. Outdoors swimming pools allow their owners to stay home and enjoy the outdoors in hot weather, rather than stay indoor or having to go somewhere else to beat the heat. Outdoor pool can also be aesthetically pleasing and add a lot of beauty to your yard and landscape and property value. Pools provide.

However, one of the un-enjoyable tasks of owning a swimming pool is in their maintenance. This is particularly true for outdoor swimming pools because unlike the owners of indoor swimming pools, the owners of outdoor swimming pools have the added task of trying to eliminate the presence of water or aquatic bugs in the outdoor swimming pools.

Aquatic bugs belong to the insect Order Hemiptera and generally comprise of two sub-species, namely Water Boatman, which looks like your classic beetle and Backswimmers, which looks similar to Water Boatman but with a more streamlined body than the Water Boatman. Water boatman are plant feeders and do not bite whereas Backswimmers are predators which make a stinging bite to subdue their preys, which generally are other bugs, tadpoles, and tiny fish. Backswimmers are know to bite people too, which is why it would be further desirous to eliminate them from swimming pools.

One of the common attributes that Water Boatman and Backswimmers both have is that although they may spend a majority of their time underwater they both breathe air from the water surface and they both are attracted to light sources especially when it's dark.

With the know attributes of the Aquatic bugs, there is a need for a trap which will, effectively and with ease to the pool owner, eliminate the presence of the Aquatic bugs in the water of outdoor swimming pool.

### SUMMARY OF THE INVENTION

The present invention comprises an outdoor swimming pool underwater aquatic-bug trap having a container with opaque sidewalls, a rear wall, an inward tapering front wall composed of a material that allows for the passage of light therethough, and an aquatic-bug holding chamber. The container includes an aquatic-bug entry orifice located in the inward tapering front wall of said container. The underwater aquatic-bug trap also includes mounting means for mounting the container underwater to a wall of an outdoor swimming pool and an aquatic-bug attracting light source located proximal the rear wall of the container for emitting light into the container to attract aquatic-bugs through the aquatic-bug entry orifice and into the aquatic-bug holding chamber.

The container may also include a mean for releasing air from the aquatic-bug holding chamber when in use underwater such as a plurality of air releasing vents located on the container sidewalls.

### BRIEF DESCRIPTION OF THE DRAWINGS

FIG. 1 is a perspective view illustrating a two-piece underwater aquatic-bug trap using a swimming pool wall recess pool light as an aquatic-bug attracting light source;

FIG. 2 is a cross-sectional view illustrating the two-piece underwater aquatic-bug trap of FIG. 1;

FIG. 3 is a cross-sectional view illustrating an underwater aquatic-bug trap having a battery-powered light source located within an aquatic-bug holding chamber;

FIG. 4 is a cross-sectional view showing a one-piece rectangular-shaped underwater aquatic-bug trap;

FIG. 5 is a front view showing the one-piece rectangular-shaped underwater aquatic-bug trap of FIG. 4;

FIG. 6 is a cross-sectional view showing a cylindrical-shaped underwater aquatic-bug trap having an enlarged front end and a plurality of aquatic-bug entry orifice;

FIG. 7 is a perspective view illustrating an alternative embodiment of a free-floating underwater aquatic-bug trap of the present invention; and

FIG. 8 is a side view of the free-floating underwater aquatic-bug trap of FIG. 7.

### DESCRIPTION OF THE PREFERRED EMBODIMENT

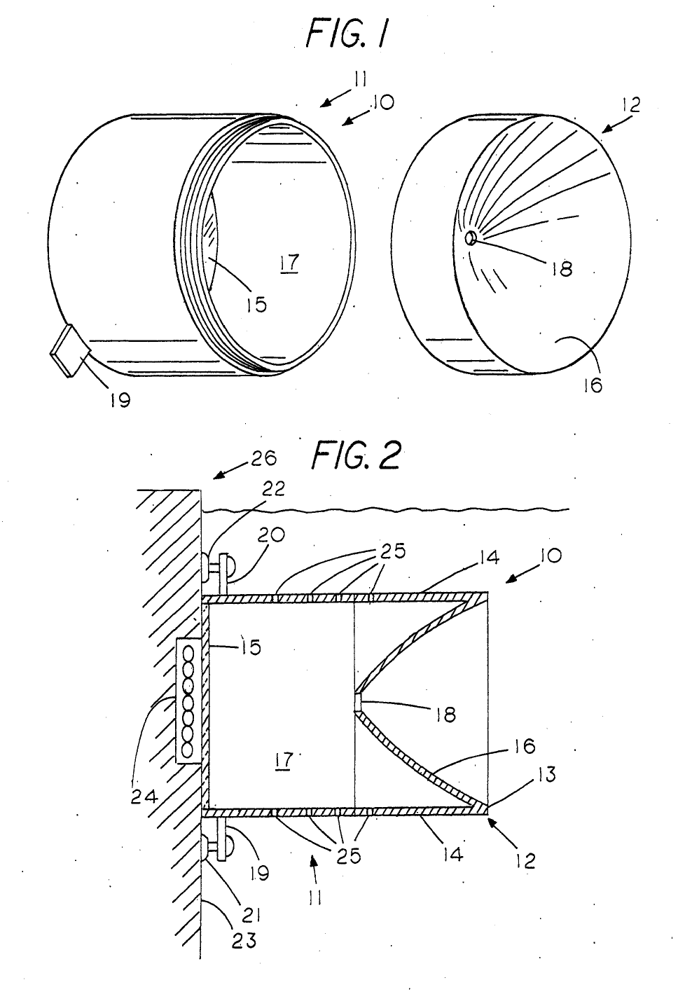

Referring to FIGS. 1 and 2, FIG. 1 is a perspective view and FIG. 2 is a cross-sectional view illustrating a two-piece embodiment of an underwater aquatic-bug trap 10 of the present invention. Underwater aquatic-bug trap 10 generally comprises an aquatic-bug trap base member 11 and an aquatic-bug trap cover 12 which when assembled by a twist-on connection method forms a cylindrical-shaped container 13 having opaque sidewalls 14, a rear wall 15, an inward tapering front wall 16 composed of a material that allows for the passage of light therethough such as for example a transparent or a translucent, and an aquatic-bug holding chamber 17.

Container 13 includes an aquatic-bug entry orifice 18 located in the inward tapering front wall 16 of container 13 and a mounting means comprising a pair of flanges 19, 20 each supporting underwater suction cups 21, 22 for mounting the rear wall 15 of container 13 completely submerged underwater to a wall 23 of an outdoor swimming pool 26.

The present invention also includes an aquatic-bug attracting light source located proximal the rear wall 15 of the container 13 for emitting light into the container 13 to attract aquatic-bugs through aquatic-bug entry orifice 18 and into aquatic-bug holding chamber 17. In the embodiment of FIGS. 1 and 2 the aquatic-bug attracting light source comprises an underwater swimming pool wall recess pool light 24 and the rear wall 15 of container 13 is also composed of a material that allows for the passage of light from recessed pool light 24 therethough.

The present invention may also include a mean for releasing air from the aquatic-bug holding chamber 17 when in use underwater. In the embodiment of FIGS. 1 and 2 the mean for releasing air from the aquatic-bug holding chamber 17 a plurality of air releasing vents 25 located along wall 14 of container 13 with each of the vents sized to prevent the escaping of aquatic-bugs therethrough. It is noted that by releasing air from the aquatic-bug holding chamber 17 when in use underwater, the aquatic-bugs that are trapped in aquatic-bug holding chamber 17 will die due to a lack of a source of air/oxygen, which will help to expedite their removal from underwater aquatic-bug trap 10. It is noted that although underwater aquatic-bug trap 10 is shown as having a plurality of air releasing vents 25 for releasing air from the aquatic-bug holding chamber, alternative embodiments of the present invention may have different means or no means at all for releasing air from the aquatic-bug holding chamber.

FIG. 3 is a cross-sectional view illustrating an alternative embodiment of an underwater aquatic-bug trap 27 of the present invention. Underwater aquatic-bug trap 27 generally comprises similar components that that of the underwater aquatic-bug trap 10, namely an aquatic-bug trap base member 28 and an aquatic-bug trap cover 28 which when assembled by a Snap-On locking connection method forms a cylindrical-shaped container 30 having opaque sidewalls 31, a rear wall 32, an inward tapering front wall 33 composed of a material that allows for the passage of light therethough such as for example a transparent or a translucent, and an aquatic-bug holding chamber 34. Similar to underwater aquatic-bug trap 10, the container 30 of underwater aquatic-bug trap 27 also includes an aquatic-bug entry orifice 34 located in the inward tapering front wall 31 of container 30.

However, unlike underwater aquatic-bug trap 10, underwater aquatic-bug trap 27 includes a mounting means comprising a pool edge holding bracket 35 for mounting the rear wall 32 of container 30 completely submerged underwater to the wall 23 of outdoor swimming pool 26. Underwater aquatic-bug trap 27 also includes a means for releasing air from the aquatic-bug holding chamber 34 comprising an air permeable mesh screen 37 located along the wall 31 of container 30, an air permeable mesh screen 37 being sized to prevent the escaping of aquatic-bugs therethrough.

Underwater aquatic-bug trap 27 further includes an aquatic-bug attracting light source aquatic-bug attracting light source comprising a waterproof submersible battery-powered light 36 mounted on the rear wall 32 of container 30 and within aquatic-bug holding chamber 34. It is noted that in the embodiment of FIG. 3 the rear wall 32 of container 30 may either be opaque or composed of a material that allows for the passage of light therethough.

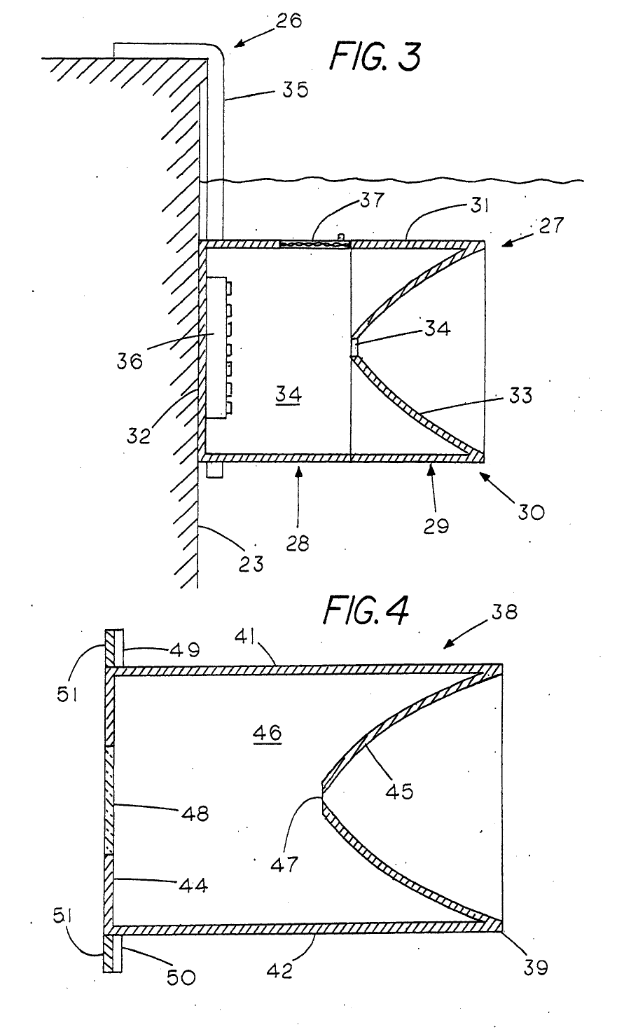

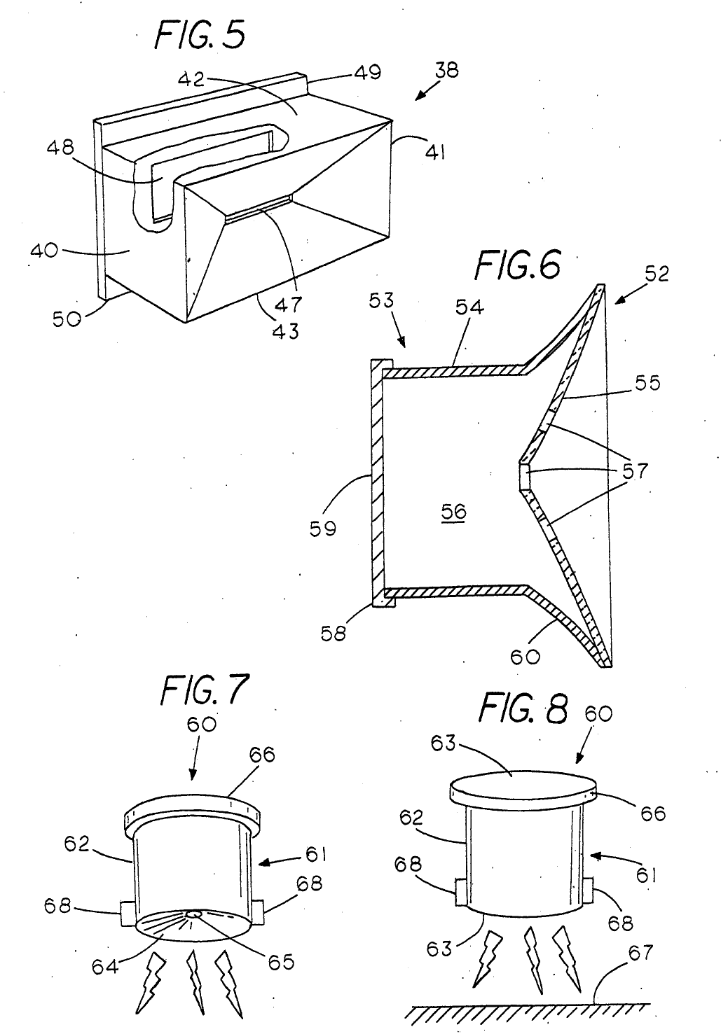

Referring to FIGS. 4 and 5, FIG. 4 is a cross-sectional view and FIG. 5 is a front view illustrating an alternative embodiment of a one-piece underwater aquatic-bug trap 38 of the present invention. Underwater aquatic-bug trap 38 generally comprises a rectangular-shaped container 39 having opaque sidewalls 40, 41, a top wall 42, a bottom wall 43, a rear wall 44, an inward tapering front wall 45 composed of a material that allows for the passage of light therethough such as for example a transparent or a translucent, and an aquatic-bug holding chamber 46. Container 39 of underwater aquatic-bug trap 38 also includes an elongated aquatic-bug entry orifice 47 located in the inward tapering front wall 45 of container 39.

Similar to the underwater aquatic-bug trap 10, one-piece underwater aquatic-bug trap 38 includes an aquatic-bug attracting light source comprising an underwater swimming pool wall recess pool light 24 (see FIG. 2). However, unlike underwater aquatic-bug trap 10, the rear wall 44 of container 39 includes a light source-receiving orifice 47 that allows for the passage of light from recess pool light 24 therethough. The light source-receiving orifice 47 also provides the added function of a mean for releasing air from the aquatic-bug holding chamber 46 when in use underwater. That is, a user during or before the mounting process of the rear wall 44 of container 39 over the recess pool light 24 of swimming pool 26 tilts container 39 in a manner, while container 39 is completely submerged in the outdoor swimming pool water, to release all the air from aquatic-bug holding chamber 46 through light source receiving orifice 47.

Rectangular-shaped container 39 also is shown to include a mounting means comprising a flange 49 extending from top wall 42 and a flange 50 extending from bottom wall 43 with each of the flanges supporting a magnetized member 51 thereon for mounting the rear wall 44 of container 39 completely submerged underwater to a wall 23 of an outdoor swimming pool 26.

FIG. 6 is a cross-sectional view illustrating another alternative embodiment of an underwater aquatic-bug trap 52 of the present invention. Underwater aquatic-bug trap 52 generally comprises similar components that that of the underwater aquatic-bug trap 10, namely a generally cylindrical-shaped container 53 having opaque sidewalls 54, an inward tapering front wall 55 composed of a material that allows for the passage of light therethough such as for example a transparent or a translucent, and an aquatic-bug holding chamber 56.

However, in the embodiment of FIG. 6 the container 53 of underwater aquatic-bug trap 52 includes an opened end 58 located distal inward tapering front wall 55 and a rear wall comprising a transparent frictional fit cover 59 enclosing container 52 with transparent frictional fit cover 59 allowing for the passage of an aquatic-bug attracting light source comprising an underwater swimming pool wall recess pool light 24 therethough. Another feature of underwater aquatic-bug trap 52 is that container 53 includes an enlarged front end 50, which leads to an increased surface area of inward tapering front wall 55 to provide greater attract of aquatic-bugs to underwater aquatic-bug trap 52. Container 53 also includes a plurality of aquatic-bug entry orifice 57 located in the inward tapering front wall 55 of container 53.

Referring to FIGS. 7 and 8, FIG. 7 is a perspective view and FIG. 8 is a side view illustrating another alternative embodiment of an underwater aquatic-bug trap 60 of the present invention. Underwater aquatic-bug trap 60 generally comprises similar components that that of the underwater aquatic-bug trap 27 of FIG. 3, namely a generally cylindrical-shaped container 61 having opaque sidewalls 62, an opaque rear wall 63, an inward tapering front wall 64 composed of a material that allows for the passage of light therethough such as for example a transparent or a translucent, an aquatic-bug holding chamber (not shown), an aquatic-bug entry orifice 65 located in the inward tapering front wall 64 of container 61, and a waterproof submersible battery-powered light (not shown) mounted within the aquatic-bug holding chamber.

However, unlike underwater aquatic-bug trap 27, underwater aquatic-bug trap 60 includes a mounting means comprising a floatation ring 66 connected proximal opaque rear wall 63 for supporting container 61 completely submerged underwater as floatation ring 66 hovers on a water line of an outdoor swimming pool 26. In the embodiment of FIGS. 7 and 8 underwater aquatic-bug trap 60 also includes an optional set of weights 68 that are preferably located diametrically opposed to each other on the opaque sidewalls 62 of cylindrical-shaped container 61 to assist in maintaining the continuous submersion of supporting container 61 underwater. Although two weights 68 are shown located on the sidewalls 62 of cylindrical-shaped container 61, alternative embodiment may include from one to a plurality of weights that are located on the sidewalls 62 or other regions of the cylindrical-shaped container 61, including but not limited to the rear wall 63, the inward tapering front wall 64, and the aquatic-bug holding chamber (not shown). Alternative embodiments of the present invention may also include an aquatic-bug trap container having a weighed inward tapering front wall to streamline the overall design of the aquatic-bug trap container.

Although the embodiment of FIGS. 7 and 8 each shows aquatic-bug entry orifice 65 and inward tapering front wall 64 facing towards a pool bottom surface 67, alternative embodiments may comprise some type of floatation device connected to the opaque sidewalls 62 of cylindrical-shaped container 61 so that the opaque sidewalls of the cylindrical-shaped container 61 run parallel to the pool bottom surface 67.

I claim:

1. An outdoor swimming pool underwater aquatic-bug trap comprising:
a container having opaque sidewalls, a rear wall, an inward tapering front wall composed of a material that allows for the passage of light therethough, and an aquatic-bug holding chamber;
an aquatic-bug entry orifice located in said inward tapering front wall of said container;
mounting means for mounting said container underwater to a wall of an outdoor swimming pool; and
an aquatic-bug attracting light source located proximal said rear wall of said container for emitting light into said container to attract aquatic-bugs through said aquatic-bug entry orifice and into said aquatic-bug holding chamber.

2. The underwater aquatic-bug trap of claim 1 including a mean for releasing air from said aquatic-bug holding chamber when in use underwater.

3. The underwater aquatic-bug trap of claim 1 wherein said container comprises an aquatic-bug trap base member and a separable aquatic-bug cover, said inward tapering front wall located on said aquatic-bug cover.

4. The underwater aquatic-bug trap of claim 1 wherein container comprises a one-piece container.

5. The underwater aquatic-bug trap of claim 1 wherein said inward tapering front wall is transparent.

6. The underwater aquatic-bug trap of claim 1 wherein said inward tapering front wall is translucent.

7. The underwater aquatic-bug trap of claim 2 wherein said mean for releasing air from said aquatic-bug holding chamber when in use underwater comprises at least one air releasing vent located on said container sidewalls.

8. The underwater aquatic-bug trap of claim 2 wherein said mean for releasing air from said aquatic-bug holding chamber when in use underwater comprises at least one air permeable meshing located on said container sidewalls.

9. The underwater aquatic-bug trap of claim 1 wherein said aquatic-bug attracting light source comprises a waterproof submersible battery-powered light mounted in said aquatic-bug holding chamber.

10. The underwater aquatic-bug trap of claim 1 wherein said aquatic-bug attracting light source comprises an underwater swimming pool wall recess pool light and said rear wall of said container is composed of a material that allows for the passage of light from said recess pool light therethough.

11. The underwater aquatic-bug trap of claim 1 wherein said aquatic-bug attracting light source comprises an underwater swimming pool wall recess pool light and said rear wall of said container includes a light source receiving orifice that allows for the passage of light from said recess pool light therethough.

12. The underwater aquatic-bug trap of claim 1 wherein said mounting means comprises a suction cup mounting mean for mounting said container underwater to a wall of an outdoor swimming pool.

13. The underwater aquatic-bug trap of claim 1 wherein said mounting means comprises pool edge holding bracket for mounting said container underwater to a wall of an outdoor swimming pool.

14. The underwater aquatic-bug trap of claim 1 wherein said rear wall of said container comprises a transparent frictional fit cover.

15. An outdoor swimming pool underwater aquatic-bug trap comprising:
a container having opaque sidewalls, a rear wall, an inward tapering front wall composed of a material that allows for the passage of light therethough, and an aquatic-bug holding chamber;
an aquatic-bug entry orifice located in said inward tapering front wall of said container;
a mean for releasing air from said aquatic-bug holding chamber when in use underwater;
mounting means for mounting said container underwater to a wall of an outdoor swimming pool; and
an aquatic-bug attracting light source located proximal said rear wall of said container for emitting light into said container to attract aquatic-bugs through said aquatic-bug entry orifice and into said aquatic-bug holding chamber.

16. The underwater aquatic-bug trap of claim 15 wherein said container comprises an aquatic-bug trap base member and an aquatic-bug cover and said inward tapering front wall is located on said aquatic-bug cover.

17. The underwater aquatic-bug trap of claim 16 wherein said aquatic-bug attracting light source comprises a waterproof submersible battery-powered light mounted in said aquatic-bug holding chamber.

18. The underwater aquatic-bug trap of claim 16 wherein said mounting means comprises a suction cup mounting mean for mounting said container underwater to a wall of an outdoor swimming pool.

19. The underwater aquatic-bug trap of claim 17 wherein said mean for releasing air from said aquatic-bug holding chamber when in use underwater comprises a plurality of air releasing vents located on said opaque sidewalls.

20. An outdoor swimming pool underwater aquatic-bug trap comprising:
an aquatic-bug attracting light source comprising an underwater swimming pool wall recess pool light;
a container having opaque sidewalls, a rear wall, an inward tapering front wall composed of a material that allows for the passage of light therethough, and an aquatic-bug holding chamber;
a light source-receiving orifice located in said rear wall to allow for the passage of light from said recess pool light therethough;
an aquatic-bug entry orifice located in said inward tapering front wall of said container;
a suction cup mounting mean for mounting said rear wall of said container underwater to a wall of an outdoor swimming pool; and
at least one air-releasing vent located in said container sidewalls for releasing air from said aquatic-bug holding chamber.
